(19) United States
(12) Patent Application Publication
(10) Pub. No.: US 2007/0284371 A1
(43) Pub. Date: Dec. 13, 2007

(54) Alcohol Beverage Apparatus Having a Bursting Disk

(75) Inventors: Ian Anderson, Cambridge (GB); Andrew R. B. Halket, Cambridge (GB)

Correspondence Address: Paul Grandinetti;LEVY & GRANDINETTI, Suite 408, 1725 K Street NW, Washington, DC, 20006-1419, US

(73) Assignee: INBEV S.A., Leuven (BE)

(21) Appl. No.: 11/597,130

(22) PCT Filed: May 20, 2005
(86) PCT No.: PCT/IB05/01376

§ 371 Date: Jun. 29, 2007

(30) Foreign Application Priority Data
May 20, 2004 (GB) 0411288.4

(51) Int. Cl. B65D 6/00; B67D 1/12; F16K 17/14; B65D 90/36

(52) U.S. Cl. 220/4.12; 137/68.23; 222/397; 220/89.2

(57) ABSTRACT

A beer keg for storing a beer under pressure has an outer wall and a pressure relief passageway extending through an outer wall of the beer keg. The beer keg has a bursting disk seated in the passageway normally closing the passageway. The disk is adapted to rupture permitting fluid to escape from the beer keg through the passageway when the pressure in the beer keg exceeds a predetermined pressure value. The keg has a releasable cap mounted thereto that covers the passageway. The releasable cap has vent openings that permit the escape of fluid from the passageway. The cap is releasable to permit access to the passageway for changing the bursting disk. Preferably, a pressure build up in the keg in excess of about 7 bar results in the bursting disk rupturing.

### FIELD OF THE INVENTION

The present invention relates to an alcohol beverage container having a bursting disk for relieving high pressure conditions.

### BACKGROUND OF THE INVENTION

It is known to contain alcohol, such as wine in bags contained in a cardboard type container. Further, it is known to use a bag inserted into a keg for storing beer in the bag. In the case of a beer keg, pressure is applied to the bag to dispense the beer from the bag and out of the keg through a valve body assembly. Further, the bag is inserted into the keg container prior to the beer being filled into the bag through the valve body assembly.

During the step of filing the bag with beer, the beer is filled into the bag under pressure. As the bag expands, air contained within the container between the container wall and the bag escapes out through another valved opening in the container. Once the bag is filled with beer, the valves are closed. In some instances, if the bag has been overfilled, the carbonated beverage may continue to expand potentially creating a beer bomb. Accordingly, there is a need to provide a safety feature compensating for potential overpressurization of the container.

### SUMMARY OF THE INVENTION

The present invention relates to a container adapted for storing alcohol beverage under pressure. The container is provided with a pressure release passageway and a bursting disk that normally closes the passageway. The bursting disk is adapted to rupture when the pressure in the container exceeds a predetermined pressure value. The use of the bursting disk provides the advantage that should the pressure within the container exceed a predetermined value, then the fluid contained within the container be it the alcohol beverage or gasses will be allowed to escape.

In accordance with an aspect of the present invention there is provided a container adapted for storing an alcohol beverage under pressure. The container comprises a pressure relief passageway extending through a wall of the container and a bursting disk seated in the passageway. The bursting disk normally closes the passageway and is adapted to rupture permitting fluid to escape from the container through the passageway when the pressure in the container exceeds a predetermined pressure value.

In accordance with another aspect of the present invention there is provided a bursting disk adapted for controlling the passage of a first fluid therethrough. The bursting disk comprises a support ring having a central opening. The bursting disk also comprises at least one membrane affixed in sealing relation with the support ring on at least one side thereof to close the central opening. The at least one membrane is adapted to rupture when the first fluid exceeds a predetermined pressure applied against the bursting disk thereby allowing the first fluid to pass through the central opening of the support ring.

It is envisaged that the support ring comprises a plastic material. Preferably, the support ring comprises polyvinylchloride plastic. The membrane may comprise one or more layers of plastic and/or foil materials. Preferably, the membrane comprises a layer of polyvinylchloride plastic coated with an aluminum foil layer. The membrane may be affixed by any suitable means to the support ring. Preferably, the membrane layer is affixed to the support ring by heat rolling.

In an alternative embodiment, the two membranes may be affixed in sealing relation with the support ring on opposite sides of the support ring.

In the preferred application, the bursting disk is adapted for use in an alcohol containing keg whereby the first and second fluids each are air.

### BRIEF DESCRIPTION OF THE DRAWINGS

For a better understanding of the nature and objects of the present invention reference may be had to the accompanying diagrammatic drawings in which:

FIG. 1 is a front elevation view of a home beer dispensing apparatus in accordance with the present invention;

FIG. 2 is a side elevation view of the home beer dispensing apparatus;

FIG. 3 is a side sectional view of the keg shown inside the beer dispensing apparatus of FIG. 2;

FIG. 4 is an enlarged exploded view of the pressure relief passageway, bursting disk and cap of the present invention;

FIG. 5 is an elevational view of the bursting disk; and,

FIG. 6 is a sectional view of the bursting disk taken at section VI-VI of FIG. 5.

### DETAILED DESCRIPTION OF THE INVENTION

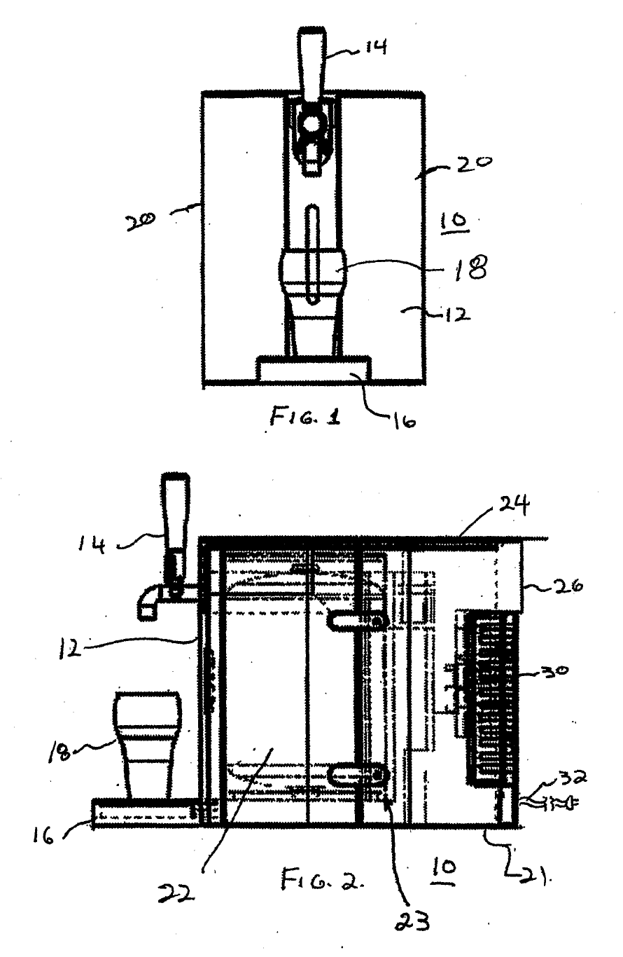

Referring to FIGS. 1 and 2 there is shown a home beer dispensing apparatus, appliance or unit 10. The dispensing apparatus 10 is primarily intended for use in domestic kitchens but may also be used in utility rooms, garages, domestic bars, caravans etc. While the preferred embodiment relates to dispensing beer, alternatively carbonated solutions or other alcohol beverages may be dispensed by apparatus 10.

The home beer dispensing apparatus 10 has a front wall 12 and a dispensing tap 14 protruding forward of the front wall 12. A drip tray 16 also protrudes forward of the front wall 12 and is adapted to support an open glass container 18 below the dispensing tap 14. The home beer dispensing apparatus 10 further has a base 21 adapted to rest on a counter top in a kitchen. The front wall 12 is formed as an extension of two pivoting side walls 20 which may be moved between closed and open positions to allow the container or keg 22 (see FIG. 2 in broken lines) to be inserted into the housing of the home beer dispensing apparatus 10. The housing of the home beer dispensing apparatus 10 further includes a top wall 24 and a rear wall 26. The rear wall 26 has a grill 30 that permits for air circulation within the home beer dispensing apparatus 10. An electrical cord 32 extends through the rear wall 26 of the apparatus 10 to provide a connection into a main electrical supply to supply electrical power to the electrical components housed within the dispensing apparatus 10. Alternatively, a 12 Volt DC supply input may be used.

The dispensing apparatus 10 has a cooling system 23 located behind and below keg 22 that is adapted to cool the keg 22 of beer when placed in dispensing apparatus 10. The dispensing apparatus 10 also dispenses the beer by providing a pressurized air supply (not shown).

Referring to FIG. 3, beer keg 22 has a general cylindrical shape with side walls 40 and a top wall or top portion 42 and a bottom wall or bottom portion 44. Both top wall 42 and bottom wall 44 are curved upwardly from the central portion of the keg 22 and are provided with a raised annular collar 46. The collars 46 provide additional support for the keg 22.

Mounted within the keg walls 40, 42 and 44 is a plastic bag 50 for containing alcohol beverage which in the preferred embodiment is beer 52.

As shown in FIG. 3, the keg is filled with beer 52 within the bag 50 and as a result the bag 50 lines the inside walls of the keg 22. As the beer 52 is dispensed from the keg 22, an air pressure is established between the walls of the bag 50 and the inside surfaces of walls 40, 42 and 44 of the keg so as to provide pressure to the bag 50 allowing the beer 52 to be dispensed from the keg 22. The air pressure space is shown at 55.

The top portion 42 and collar 46 located in the top portion 42 of keg 22 has a keg dispensing device or valve 60 extending through the top collar 46. The keg dispensing device 60 is connected to the tap 14 of the beer dispensing apparatus 10 by a tube or tap connection (not shown) extending from the keg dispensing device 60 at its top end 62.

The dispensing device 60 has a dip tube 66 that extends into the keg 22 within bag 50 so as to provide a remote open end 64 adjacent the bottom portion 44 of the keg for drawing beer 52 from the bottom portion 44 of the keg 22. Beer 52 is drawn through open end 64, up hollow tube 66 out through end 62 to the tap 14 (FIG. 1). For filling, the beer is inserted through valve end 62 down the tube 66 and out end 64 into bag 50. The dual direction flow of beer 52 into and out through end portion 64 is illustrated by arrows 67 in FIG. 3.

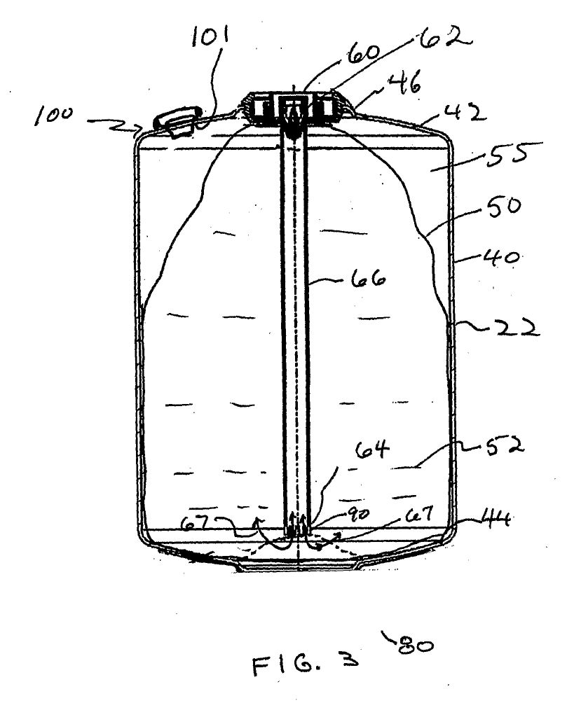

Referring to FIGS. 3 through 6, the keg 22 is shown to include a pressure relief passageway 100 mounted in a top portion of the keg wall 42. The air relief passageway 100 has a tube-like member 102 that is pressed fitted through the aperture 101 of the keg 22. The tube-like member 102 has hook like members 103 that secure the tube-like member 102 to the wall 42 of the keg 22 in a latching manner. The tube-like member 102 has an inner surface portion 110 for seating a bursting disk 104. The tube-like member 102 has an outer rim surface portion 112 for receiving a releasable cap 106. It should be understood that the passageway 100 in effect extends through the structure provided by the tube-like member 102.

The bursting disk 104 is seated on the rim surface portion 110 of the passageway 100 for normally closing the passageway 100. The bursting disk 104 is adapted to rupture to permit fluid to escape from the keg 22 through the passageway 100 when the pressure in the keg exceeds a predetermined pressure value. In the embodiment shown, this pressure value is preferably about 7 bar±10%.

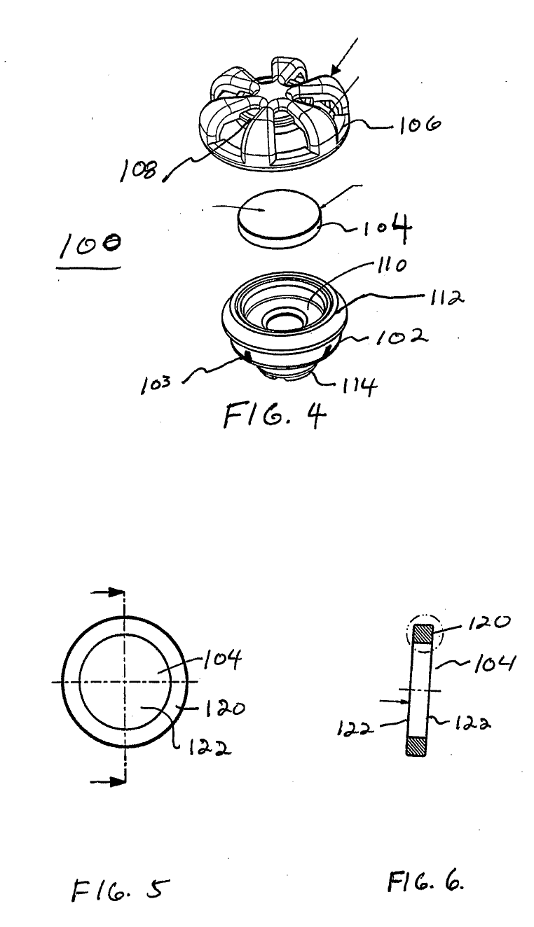

The bursting disk 104 comprises a support ring 120 having a central opening 121 as shown in FIG. 5. Preferably the ring 120 is made from polyvinylchloride plastic. The ring 120 has at least one membrane affixed thereto on at least one side thereof. In the illustrated embodiment, two membranes 122 are affixed to opposing sides of the support ring 120. The membranes 122 each preferably each comprise a layer of polyvinylchloride plastic coated with an aluminum foil layer. The membranes 122 are heat rolled onto the ring 120. The resulting bursting disk 104 has an air pocket 123 (FIG. 6) trapped within the ring 120 and between the membranes 122. The choice of membrane material, and its thickness determine the pressure at which the bursting disk ruptures membranes 122 allowing fluid to escape though the ring 120.

A releasable cap 106 is mounted by suitable means such as, for example, threads, with the outer rim surface portion 112 of the tube-like member 102 to thereby encapsulate the bursting disk 104 within the passageway 100. It should be understood that the releasable cap 106 effectively holds the bursting disk in place against the inner rim surface portion 110 of the tube-like member 102. The releasable cap 106 has vent openings 110 that permit the escape of fluid from the passageway 100 through the vent openings in the event the bursting disk is ruptured. The cap 106 is releasable from the tube-like member 102 so as to provide access to the passageway 100 so as to change or replace a ruptured bursting disk with a non ruptured bursting disk.

It should be understood that, while the keg 22 has been described in the illustrated embodiment for use with a beer appliance unit 10, the invention may be used in kegs and other alcohol containers which may find use in applications other than in appliance units.

What is claimed is:

1. A container adapted for storing an alcohol beverage under pressure, said container comprising:
a pressure relief passageway extending through a wall of the container; and,
a bursting disk seated in the passageway for normally closing the passageway and adapted to rupture permitting fluid to escape from the container through the passageway when the pressure in the container exceeds a predetermined pressure value.

2. The container of claim 1 further comprising a releasable cap mounted to the container covering the passageway, the releasable cap having at least one vent opening permitting the escape of fluid from the passageway therethrough, and the cap being releasable to permit access to the passageway for changing the bursting disk.

3. The container of claim 2 further comprising an aperture in the wall of the container into which a tube-like member is mounted in sealing relation therewith, the tube-like member having an inner rim surface portion for seating the bursting disk and an outer rim surface portion for receiving the releasable cap, wherein the passageway extends through the tube-like member.

4. The container of claim 3 wherein the tube-like member is press-fitted through the aperture of the container and has hook-like members for securing the tube-like member to the container.

5. The container of claim 1 wherein the predetermined pressure value is about 7 bar.

6. The container of claim 1 wherein the bursting disk comprises a ring having at least one membrane extending across at least one side of the ring.

7. The container of claim 6 wherein the ring comprises a polyvinylchloride plastic and the at least one membrane comprises a layer of polyvinylchloride plastic coated with aluminum foil.

8. A beer keg adapted for storing a beer under pressure, said beer keg comprising:
an outer wall;
a valve assembly mounted in the outer wall for filling and dispensing beer from the beer keg and for pressurizing the beer keg;
a beer bag mounted to the valve assembly within the beer keg for storing the beer;
a pressure relief passageway extending through a outer wall of the beer keg; and,
a bursting disk seated in the passageway for normally closing the passageway and adapted to rupture permitting fluid to escape from the beer keg through tlie passageway when the pressure in the beer keg exceeds a predetermined pressure value.

9. The beer keg of claim 1 further comprising a releasable cap mounted to the beer keg covering the passageway, the releasable cap having at least one vent opening permitting the escape of fluid from the passageway therethrough, and the cap being releasable to permit access to the passageway for changing the bursting disk.

10. The beer keg of claim 2 further comprising an aperture in the outer wall of the beer keg into which a tube-like member is mounted in sealing relation therewith, the tube-like member having an inner rim surface portion for seating the bursting disk and an outer rim surface portion for receiving the releasable cap, wherein the passageway extends through the tube-like member.

11. The beer keg of claim 3 wherein the tube-like member is press-fitted through the aperture of the beer keg and has hook-like members for securing the tube-like member to the beer keg.

12. The beer keg of claim 1 wherein the predetermined pressure value is about 7 bar.

13. The beer keg of claim 1 wherein the bursting disk comprises a ring having at least one membrane extending across at least one side of the ring.

14. The beer keg of claim 6 wherein the ring comprises a polyvinylchloride plastic and the membrane comprises a layer of polyvinylchloride plastic coated with aluminum foil.

15. A bursting disk adapted for controlling the passage of a first fluid therethrough comprising:
a support ring having a central opening; and,
at least one membrane layer affixed to the support ring on at least one side thereof to close the central opening, wherein the membrane layer is adapted to rupture when the first fluid exceeds a predetermined pressure applied against the bursting disk thereby allowing the first fluid to pass through the central opening of the support ring.

16. The bursting disk of claim 15 wherein the support ring comprises a plastic material.

17. The bursting disk of claim 16 wherein the support ring comprises polyvinylchloride plastic.

18. The bursting disk of claim 15 each of the at least one membrane comprises a layer of polyvinylchloride plastic coated with an aluminum foil layer.

19. The bursting disk of claim 18 wherein the at least one membrane is affixed to the support ring by heat rolling.

20. The bursting disk of claim 17 wherein each of the at least one membrane comprises a layer of polyvinylchloride plastic coated with an aluminum foil layer.

21. The bursting disk of claim 20 wherein the at least one membrane is affixed to the support ring by heat rolling.

22. The bursting disk of claim 15 wherein the predetermined pressure value is about 7 bar.

23. The bursting disk of claim 14 wherein each of the first fluid is air.
